(19) United States
(12) Patent Application Publication
(10) Pub. No.: US 2025/0265720 A1
(43) Pub. Date: Aug. 21, 2025

(54) System and Method for Identifying Fronts through Gradient Generation and High Gradient Value Tracing

(71) Applicant: The Government of the United States of America, as represented by the Secretary of the Navy, Arlington, VA (US)

(72) Inventors: Mark David Lewis, Diamondhead, MS (US); Elizabeth Mary Douglass, Slidell, LA (US); Sean Christopher McCarthy, Mandeville, LA (US)

(73) Assignee: The Government of the United States of America, as represented by the Secretary of the Navy, Arlington, VA (US)

(21) Appl. No.: 19/057,118

(22) Filed: Feb. 19, 2025

Related U.S. Application Data
(60) Provisional application No. 63/555,323, filed on Feb. 19, 2024.

(51) Int. Cl. G06T 7/13; G06T 11/20

(52) U.S. Cl. CPC G06T 7/13; G06T 11/206; G06T 2207/10032; G06T 2207/30181

(57) ABSTRACT

A method of identifying a frontal boundary. The method may include identifying in a bounding area a first pixel having a gradient value above a threshold, generating a digital tree with the first pixel as a root node of the digital tree, and identifying based on (i) the digital tree and (ii) an orientation direction, a set of adjacent pixels with highest gradient values in proximity to the first pixel. The method may include for each adjacent pixel in the set of pixels, determining whether the corresponding gradient value is greater than a threshold, sorting one or more paths in the digital tree associated with pixels in the queue based on a respective performance measure, identifying the frontal boundary based on the one or more sorted paths, and determining based on the identified frontal boundary, a candidate frontal boundary in a new data set.

### CROSS-REFERENCE

This Application is a nonprovisional application of and claims the benefit of priority under 35 U.S.C. § 119 based on U.S. Provisional Patent Application No. 63/555,323 filed on Feb. 19, 2024. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #212003.

### TECHNICAL FIELD

The present disclosure is related to identifying a location of separation between fluid masses, and more specifically to, but not limited to, automating the tracing of lines through neighboring high value pixels of satellite observed or modeled gradient images to identify the frontal boundary between two fluid masses.

### BACKGROUND

Existing operations perform manual delineation of frontal boundary lines by drawing lines on satellite and modeled product images. Since these frontal boundary files are traditionally drawn by hand, this process is very time consuming and diverts human resources to the task. Disclosed embodiments provide a solution to this problem.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present disclosure provides for a method of identifying a frontal boundary between a first fluid mass and a second fluid mass based on a fluid property. The method may include receiving, by a processing device, a historical data set associated with an initial fluid mass, the historical data set comprising a bounding area, the initial fluid mass comprising the first and second fluid masses, and identifying, by the processing device, in the bounding area a first pixel having a gradient value above a threshold, the gradient value being associated with a fluid characteristic variable. The method may include pushing, by the processing device, the first pixel into a queue, and setting, by the processing device, a heading having an orientation direction based on a location associated with the first pixel. The method may include generating, by the processing device, a digital tree with the first pixel as a root node of the digital tree, the digital tree comprising one or more paths of one or more pixels associated with the bounding area. The method may include while repeating a process of popping pixels from the queue: identifying, by the processing device, based on (i) the digital tree and (ii) the orientation direction, a set of adjacent pixels with highest gradient values in proximity to the first pixel, and updating, by the processing device, a respective heading for each of the adjacent pixels in the set of pixels. The method may include for each adjacent pixel in the set of pixels, determining, by the processing device, whether the corresponding gradient value is greater than a threshold, and responsive to a corresponding gradient value for one of the adjacent pixels being less than the threshold, searching, by the processing device, along the heading of the corresponding adjacent pixel and if found, pushing a found pixel to the queue responsive to determining that the corresponding gradient value changes to be above the threshold when searching. The method may include responsive to a corresponding gradient value for one of the adjacent pixels being greater than or equal to the threshold, pushing, by the processing device, the corresponding adjacent pixel to the queue responsive to determining that a performance measure associated with the fluid characteristic variable of the corresponding adjacent pixel is greater than the one or more pixels in a visitation map comprising one or more pixels already evaluated, and sorting, by the processing device, one or more paths in the digital tree associated with pixels in the queue based on a respective performance measure associated with the fluid characteristic variable. The method may include identifying, by the processing device, the frontal boundary based on the one or more sorted paths, and determining, by the processing device, based on the identified frontal boundary, a candidate frontal boundary in a new data set, the new data set being related to the bounding area comprised in the historical data set.

### BRIEF DESCRIPTION OF THE DRAWINGS

FIG. 1 illustrates an example flow diagram for identifying fronts through gradient generation and high gradient value tracing, in accordance with one or more aspects.

FIG. 2 illustrates a flow diagram of an example method for a Front Line (fline) Gradient Tracing Algorithm, in accordance with one or more aspects.

FIG. 3 illustrates an example schematic flow of a digital tree, in accordance with one or more aspects.

FIG. 4 illustrates Modeled Data of Sea Surface Temperature (SST) and Sea Surface Height (SSH) acquired from Hybrid Coordinate Ocean (HYCOM) Model, in accordance with one or more disclosed aspects.

FIG. 5 illustrates Observed Data acquired from Visible Infrared Imaging Radiometer Suite (VIIRS) through Ocean Color Website, in accordance with one or more disclosed aspects.

FIG. 6 shows an illustration of the Sobel Gradient of SST over GIUK: June 2015, in accordance with one or more aspects.

FIG. 7 shows an illustration of the WGW Front: Mar. 26, 2016 Modeled SST, in accordance with one or more disclosed aspects.

FIG. 8 shows show an illustration of the WGW Front: Mar. 26, 2016 Modeled SSH, in accordance with one or more disclosed aspects.

FIG. 9 shows show an illustration of the DSE Front: Mar. 26, 2016 Modeled SST, in accordance with one or more disclosed aspects.

FIG. 10 shows show an illustration of the DSE Front: Mar. 26, 2016 Modeled SSH, in accordance with one or more disclosed aspects.

FIG. 11 shows an illustration of the EGE Front: Mar. 26, 2016 Modeled SST, in accordance with one or more disclosed aspects.

FIG. 12 shows an illustration of the EGE Front: Mar. 26, 2016 Modeled SSH, in accordance with one or more disclosed aspects.

FIG. 13 shows an illustration of VIIRS SST: DSE in Green: WGW, EGE, EIN, IFS in Blue, in accordance with one or more disclosed aspects.

FIG. 14 shows an illustration, in the image of sea surface temperature gradients (modeled Aug. 1, 2015 data), of a frontal boundary between the warmer water mass to the south and the colder water mass to the north at the Iceland Faro Primary (IFS) front that was generated in accordance with one or more disclosed aspects.

FIG. 15 shows an illustration, in the image of sea surface height gradients (modeled Aug. 1, 2015 data), of a frontal boundary between the less dense water mass to the south from the denser water mass to the north at the IFS front that was generated in accordance with one or more disclosed aspects.

FIG. 16 shows an illustration of Both Green Line Depicting SST IFS front and Blue Line Depicting SSH IFS Front on Aug. 1, 2015 SSH Image, in accordance with one or more disclosed aspects.

FIG. 17 illustrates an example method in accordance with one or more disclosed aspects.

FIG. 18 illustrates an example computer system, in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

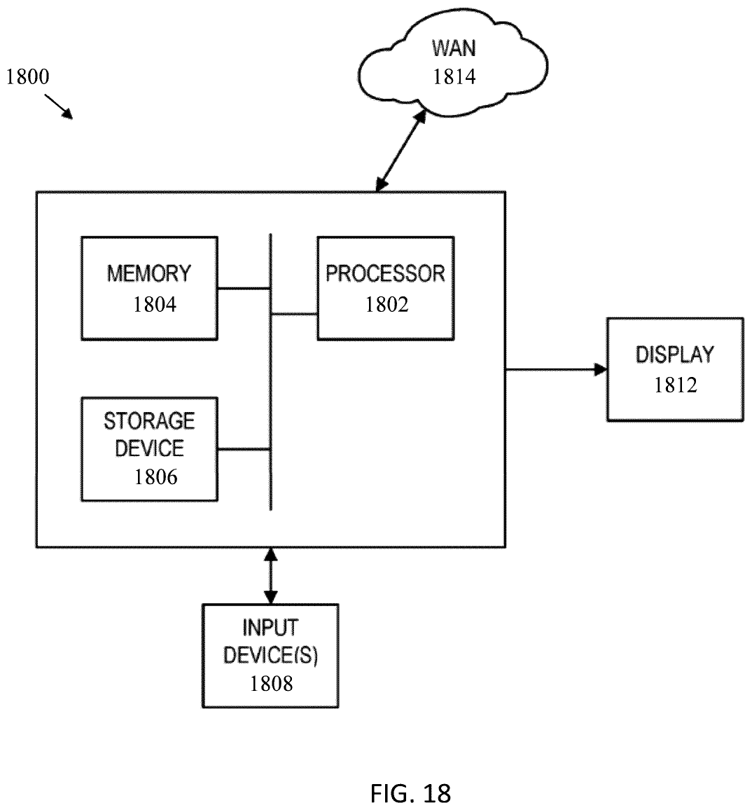

Disclosed embodiments provide for methods and systems for identifying fronts through gradient generation and high gradient value tracing, in accordance with one or more aspects disclosed herein. One or more aspects described herein may be performed by a computer, computing device, processing device, or the like, such as the one described herein and shown in FIG. 18.

Disclosed embodiments provide for a system and method to automate the tracing of lines through neighboring high value pixels of satellite observed or modeled gradient images to identify the frontal boundary between two water masses.

Convergence zones in the ocean are important features. They are associated with strong gradients in one or more ocean characteristics, such as Sea Surface Temperature (SST), Sea Surface Height (SSH) or ocean color products such as chlorophyll. However, the gradients in these different ocean variables can indicate different characteristics of ocean structure and phenomenon ad different times. For example, SST gradients in the Gulf of Mexico during the spring can depict frontal zones. However, in the summer, when the SST across the Gulf warms to uniform temperatures, the strong gradients from earlier in the year will decrease. At this time gradients in the SSH might provide more information about the current ocean structure. Also, gradients in various ocean color products, such as chlorophyll, can provide insight into boundaries of nutrient concentrations, impacting distributions of biological organisms. A process to automatically detect frontal boundaries based on gradient data fields of SST, SSH and ocean color products is presented.

Disclosed embodiments provide for creating gradient raster images of modeled and observed data sources and constructing a vector line through the cells of high gradient in those images. Disclosed embodiments provide for 1) acquiring modeled and observed data products such as SST and SSH; 2) generating gradient grids of these data sources; and tracing through cells of high values in the gradient images and store them as vector lines.

Disclosed embodiments can, in some cases, begin with identifying which observed or modeled ocean product data set (“current product”) is to be included in the current run of the process. It also requires the geographic coordinates defining the region of interest (ROI) for the current run and a list of the known fronts of interest in the ROI. In addition, it requires historical data sets of the current product for this ROI to use in building a bounding area within which each of the fronts of interest meander during the course of the year.

The following is one example flow of an operating system or method in accordance with disclosed embodiments:
1. Subset the current product to the coordinates of the ROI
2. Generate gradient images based on one of available gradient method (Sobel, Pickens, etc.)
3. Perform the gradient tracing algorithm based on the desired bounding files for fronts of interest

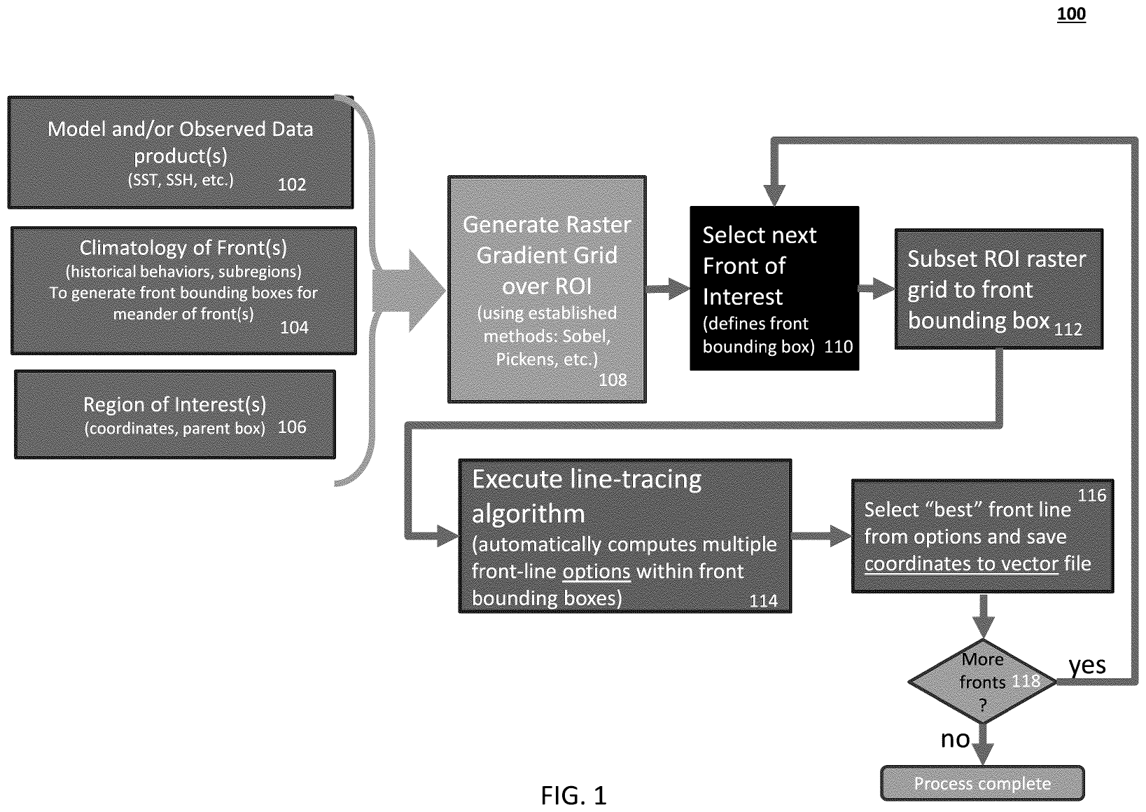

FIG. 1 illustrates an example flow diagram 100 for identifying fronts through gradient generation and high gradient value tracing in accordance with one or more aspects described herein.

Steps 102, 104, and 106 may include generating gradient raster images from a set of data, such as one or more historical data sets, such as based on a fluid property or characteristic. For example, the set of data may include model and/or observed data (such as SST, SSH, etc.), climatology of front(s) (historical behaviors, subregions) to generate front bounding boxes for meandering of front(s), and/or one or more regions of interest (coordinates, parent box).

Step 108 may include using the gradient raster images to generate a geographic bounding area (Region of Interest, ROI, or the like) around the breadth of the high gradient values over each known front of interest.

Step 110 may include selecting the next front of interest. Step 112 may include defining a front bounding box, such as a subset ROI raster grid to front bounding box. According to some aspects, for each front of interest the coordinates of this bounding area may be written to a file for storage.

Step 114 may include organizing these bounding area files to be used as input to the gradient tracing program, and may include executing the line-tracing algorithm, which may compute multiple front-line options within front bounding boxes.

Step 116 may include selecting a best front line(s) from the options and save the coordinates to a vector file.

Step 118 may include determining whether there may be more fronts of interest. If yes, then the process may go to step 110. If not, then the process may end.

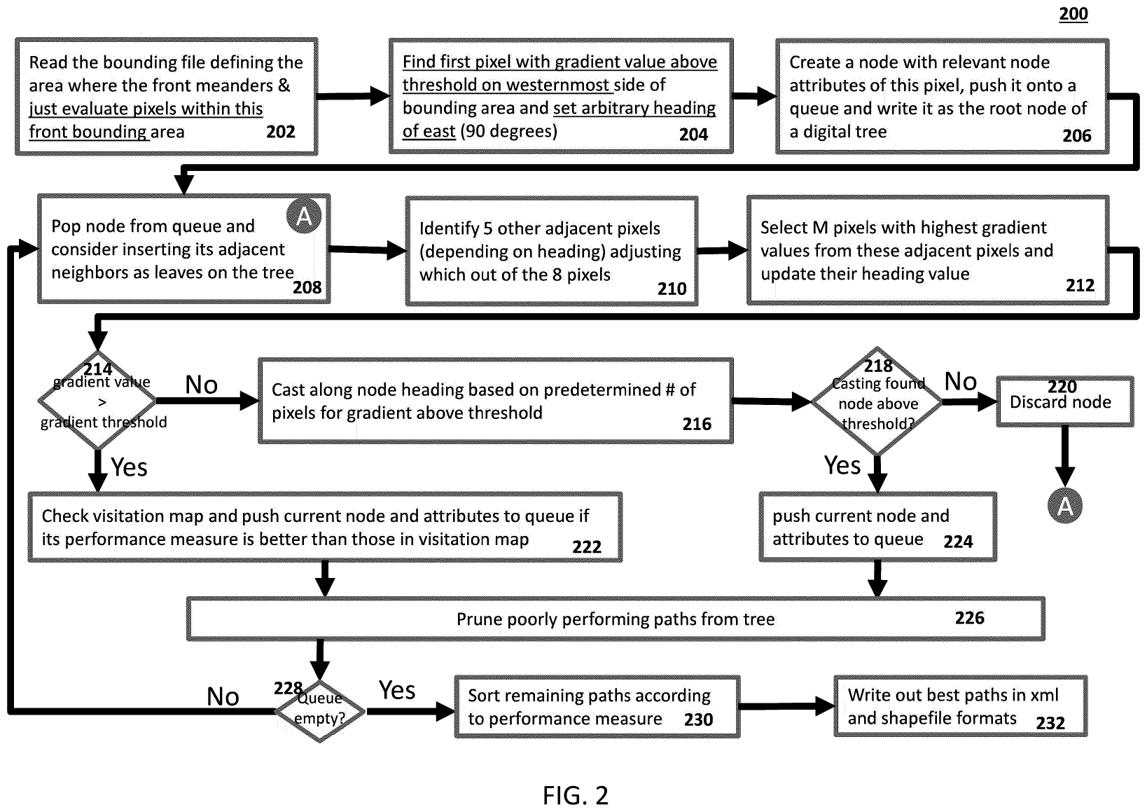

FIG. 2 illustrates a flow diagram 200 of an example method for a Front Line (fline) Gradient Tracing Algorithm in accordance with one or more aspects described herein.

Step 202 may include reading the bounding file defining the area where the front meanders and just evaluate pixels within this bounding area.

Step 204 may include finding first pixel with gradient value above threshold on westernmost side of bounding area and set arbitrary heading, such as in one example, of east (90 degrees).

Step 206 may include creating a node with relevant node attributes of this pixel, push it onto a queue and write it as the root node of a digital tree (e.g., binary tree or the like). Reference to pixels may include pixel or node herein, and reference to node may include pixel or node herein.

Step 208 may include popping a node from queue and consider inserting the node's adjacent neighbors as leaves on the tree.

Step 210 may include identifying one or more adjacent pixels (e.g., 5 adjacent pixels) to the original pixel and adjusting and/or determining which out of the 8 pixels to consider depending on heading. In some cases, other numerical values may be used.

Step 212 may include selecting M pixels (e.g., 3 pixels in some cases) with the highest gradient values from these adjacent pixels and updating their heading value. According to some aspects, the methods consider paths along M highest gradient neighbors and a visitation map of N levels. In some cases, other numerical values may be used. According to some aspects, the visitation map may be a map of pixels that have been considered.

Step 214 may include determining whether the gradient value is greater than the gradient threshold for inclusion in front line.

If the gradient value is not greater than the gradient threshold, then the process may proceed to searching along the heading until value is above threshold and use that pixel as candidate for inclusion in queue. For example, as described herein, a list of pixels that are going to be evaluated come from the queue. High performing pixels can be pushed on the queue. The children pixel nodes of high-performance pixels are evaluated to determine if the children pixel nodes should be pushed onto the queue. After the last remaining pixel in the queue is evaluated, the paths can be sorted.

Step 216 may include casting along node heading based on a predetermined number of pixels searching for the gradient above threshold based on a historical feature seen for the front.

At step 218, it is determined if the casting found a node above the threshold, such as by determining if the bounding area is reached. If not, then at step 220, such as if the bounding area is reached, discarding this pixel and node and break to consider next node in queue by continuing to step 208. If the casting found a node above the threshold, then step 224 may include pushing currently found node and attributes to the queue. The process may continue to step 226.

At step 214, if gradient value is greater than gradient threshold, then step 222 may include checking visitation map and putting the pixel in the visitation map if fewer than N paths pass through pixel location, such as by pushing current node and attributes to queue if its performance measure is better than those in visitation map.

For example, if the current pixel is already part of N paths and if current pixel's route has better performance value, replacing lowest performing pixel in visitation map with current pixel, else discarding current pixel from consideration and break to consider next node in queue.

In some cases, the process may include creating a node with relevant node attributes of this pixel, and push it onto the queue.

Step 226 may include pruning poorly performing paths from the tree.

Step 228 may include determining whether the queue is empty. If the queue is not, then the process may continue to step 208. If the queue is empty, then step 230 may include sorting the remaining paths according to performance measure. In some cases, the process may include performing depth-first listing/searching of tree to create list of paths through gradient field. For example, evaluating starting at the top and go all the way down on the left side. Then going down the next path over by removing the last entry from the tree, where the second path is slightly different from the first path, and repeating until all of the paths are considered.

Step 232 may include identifying the best performing paths, such as by writing out the best paths, such as in a format like xml or shapefile formats. The identified best performing paths may be used to identify the frontal boundary in the data.

According to some aspects, after identifying the frontal boundary based on the one or more sorted paths, one or more aspects may then be used to determine based on the identified frontal boundary, a candidate frontal boundary in a new data set, where the new data set is related to the bounding area in the original data set (e.g., similar geographic area, data from a similar time of year, and/or the like).

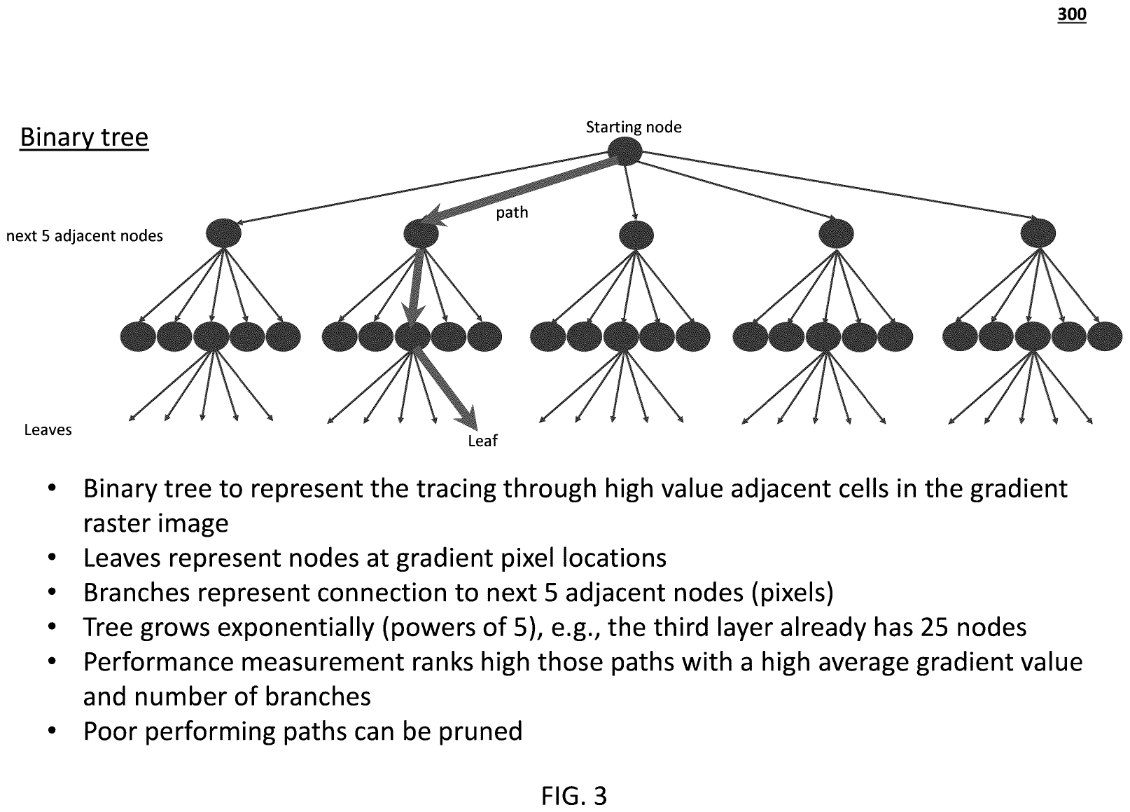

One or more aspects described herein provide for a tracing approach using construction and searching a digital tree 300, such as described herein (e.g., in FIG. 2 or the like). FIG. 3 illustrates an example schematic flow of a digital tree (e.g., binary tree or the like).

As shown in FIG. 3, the binary tree 300 can represent the tracing through high value adjacent cells in the gradient raster image. According to some aspects, the leaves can represent a node at gradient pixel location, and a branch can represent a connection to the next 5 adjacent nodes (e.g., pixels). According to some aspects, the tree 300 grows exponentially (powers of 5 in this example), such as shown by the third layer already having 25 nodes represented. In some cases, performance measurement ranks high those paths with a high average of gradient values and number of branches. Lower ranked and poor performing paths may be pruned.

Reduction to Practice example for identifying the fronts

Disclosed aspects provide for identifying a frontal boundary between a first fluid mass and a second fluid mass based on a fluid property (e.g., temperature, density, other measurement, etc.). For example, disclosed aspects have been performed on satellite observed sea surface temperature and sea surface height data as well as modeled sea surface height and sea temperature data.

According to some aspects, disclosed embodiments acquire composite 10 km Sea Surface Temperature from satellite sensors. Code was developed to:
Generate gradient fields for these data sets
Subset the gradient field to the Greenland Iceland UK (GIUK) Gap region
Display these gradient grids
Mask the GIUK fronts by manually drawing the area in which each of the 9 fronts meander. Disclosed embodiments, however, allow for the automation of the drawing of fronts using, for example, climatological data.
Display the gradients in the masked areas to highlight the gradients in each of the 9 fronts
Development of a high gradient tracing algorithm using a digital tree was initiated

The following is an example technique for identifying fronts in accordance with one or more disclosed aspects.

Example tasks to identify the fronts:
1. Subset K10 data at GIUK extent (Min Lat=50N, Max Lat=80N, Min Lon=50W, Max Lon=35E) for May 5, 2016-May 12, 2016
2. Pick the GIUK region file for one of these dates to develop automation tools
3. Determine the spatial range inside this GIUK extent for 9 labeled fronts
a) Create 9 raster grids with the same number of rows and columns as the GIUK extent
   b) Initialized all raster cells to 0
   c) Let each of the 9 raster grids represent one of the labeled fronts
   d) For each raster grid assign the raster grid values to 1 where the associated front has historically meandered
4. Open the K10 GIUK region data for the development date and copy it to a GIUK “front” output data grid file
5. For each of the 9 fronts, the masked areas were evaluated during the delineation process.

Some assumptions may include:
1. Monthly averages of the K10 data were used, which created clean data grids, free from cloud contamination.
2. This will let us focus on the pattern/front identification and not burn our time on cloud contamination issues.
3. This allowed us to successfully show progress in the front detection with K10 data.
4. GIUK has fewer fronts than some other areas, and so it would have a limited number of fronts.
5. The historical extent of each front was used to automate the creation of the front bounding mask.

Disclosed aspects have been performed on satellite observed sea surface temperature and sea surface height data as well as modeled sea surface height and sea temperature.

Reduction to Practice Study

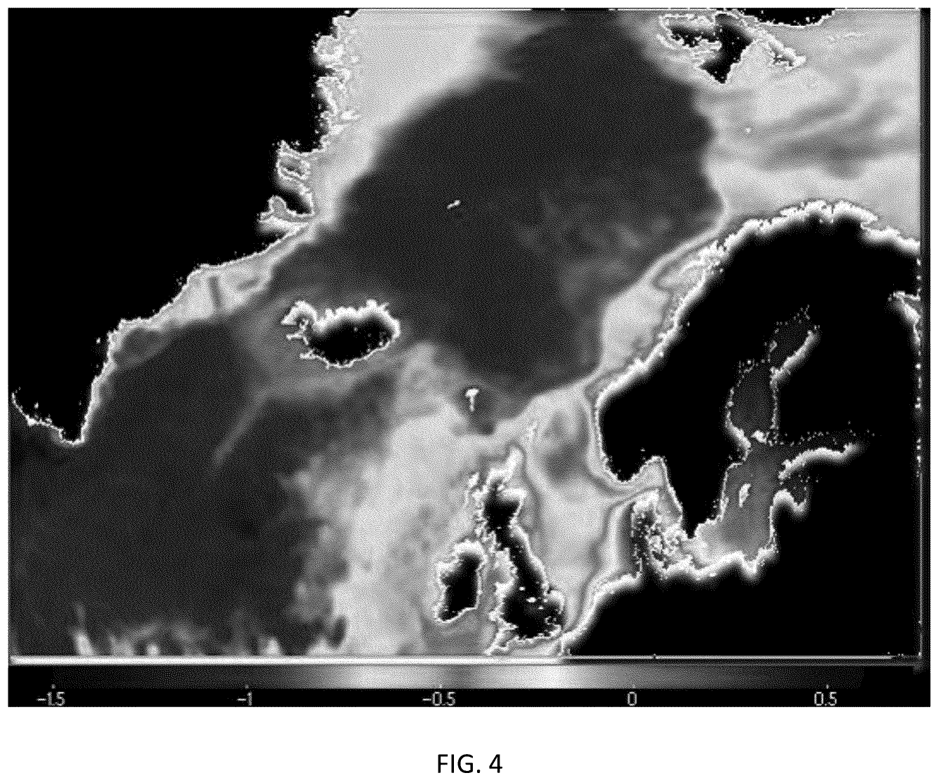

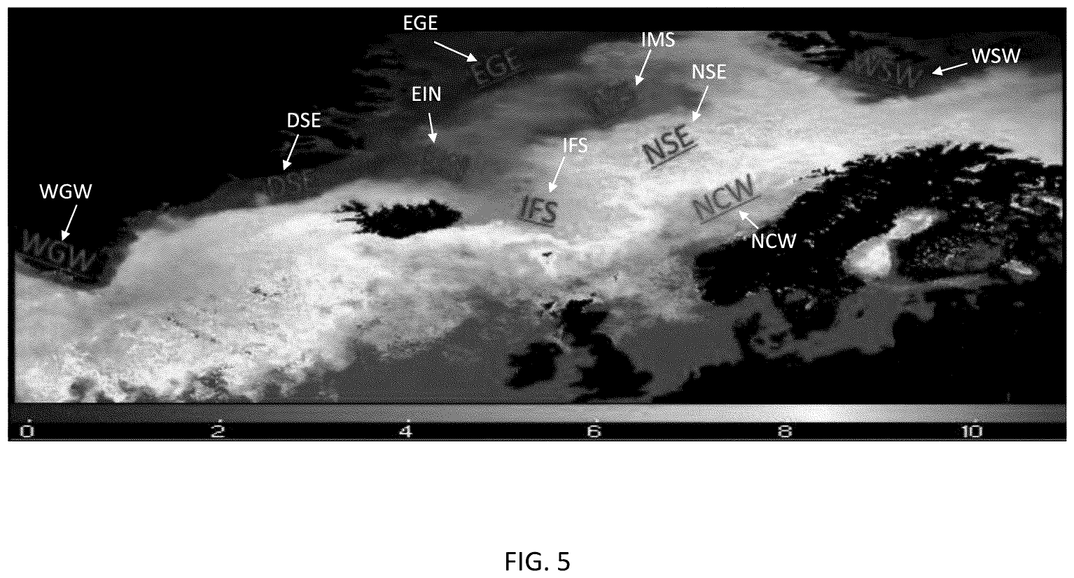

The reduction to practice study includes looking at the Greenland Iceland United Kingdom (GIUK) Gap. FIG. 4 illustrates Modeled Data of SST and SSH acquired from Hybrid Coordinate Ocean (HYCOM) Model, in accordance with one or more disclosed aspects. FIG. 5 illustrates Observed Data acquired from Visible Infrared Imaging Radiometer Suite (VIIRS) through Ocean Color Website (https://oceandata.sci.gsfc.nasa.gov), in accordance with one or more disclosed aspects.

According to some aspects, the known fronts of interest in the GIUK Gap include:
1. WGW: West Greenland Primary
2. EGE: East Greenland Primary
3. DSE: Denmark Strait Primary
4. EIN: East Icelandic Primary
5. IFS: Iceland Faeroe Primary
6. JMS: Jan Mayen Primary
7. NCW: Norwegian Coastal Primary
8. NSE: Norwegian Sea Primary
9. WSW: West Spitzbergen Primary

According to some aspects, disclosed embodiments include Gradient Generation, one example of which is described herein and/or below.

Gradients can be generated, according to some aspects, using the following example.
Subset the input image according to study area on latitude and longitude values regardless of projection.
Create gradients of input data using Sobel and/or Prewitt gradient algorithms. According to some aspects, the Laplacian gradient may be used.

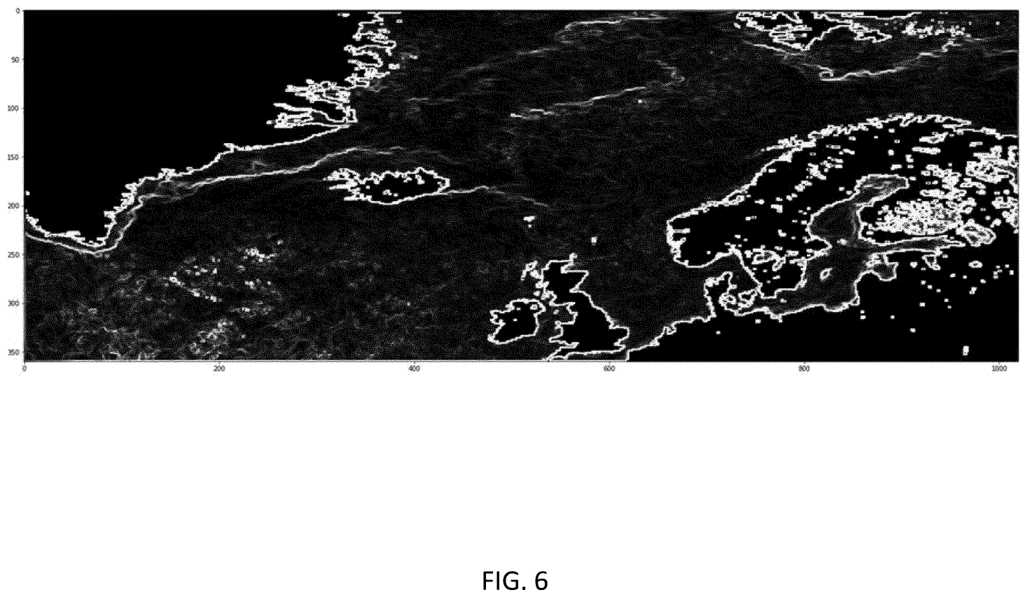

FIG. 6 shows an illustration of the Sobel Gradient of SST over GIUK: June 2015, in accordance with one or more aspects described herein.

According to some aspects, disclosed embodiments include Gradient Tracing Algorithm, one example of which is described herein and below.
Generate a mask defining the area where the front meanders and just evaluate pixels with locations in this mask (e.g., VIIRS SST: DSE in Green: WGW, EGE, EIN, IFS in Blue).
Find first pixel on westernmost side and set arbitrary heading of east
Put node information of this pixel in node attributes and push node onto queue and as the root of a digital tree
Pop node from queue and consider inserting its adjacent neighbors as leaves on the tree
Identify 5 adjacent pixels out of the 8 pixels along current heading
Select 3 pixels with highest gradient values and update their heading
If value is greater than threshold, search along heading until value is above threshold and use that pixel
Check visitation map and put pixel in map if fewer than N paths pass through pixel location
If current pixel is already part of N paths and if current pixel's route has better performance value, replace lowest performing pixel in visitation map with current pixel, else discard current pixel
Put node information for remaining pixels in nodes' attribute and push nodes onto queue and insert in tree
Prune poorly performing paths from tree.
Repeat this step by popping next node from queue and stop when the queue is empty
Perform depth-first listing of tree to create paths through gradient field
Sort remaining paths according to performance measure

Using these developed programs, the Sobel gradient was generated on various modeled and observed data sets and the line tracing algorithm was performed for selected front masks. After completion the best lines depicting the gradient fronts in SST and SSH for the modeled data and SST for the observed data were inspected. The algorithm was performed on modeled and observed data sets. Results from different product sources can be viewed individually or combined to inspect results.

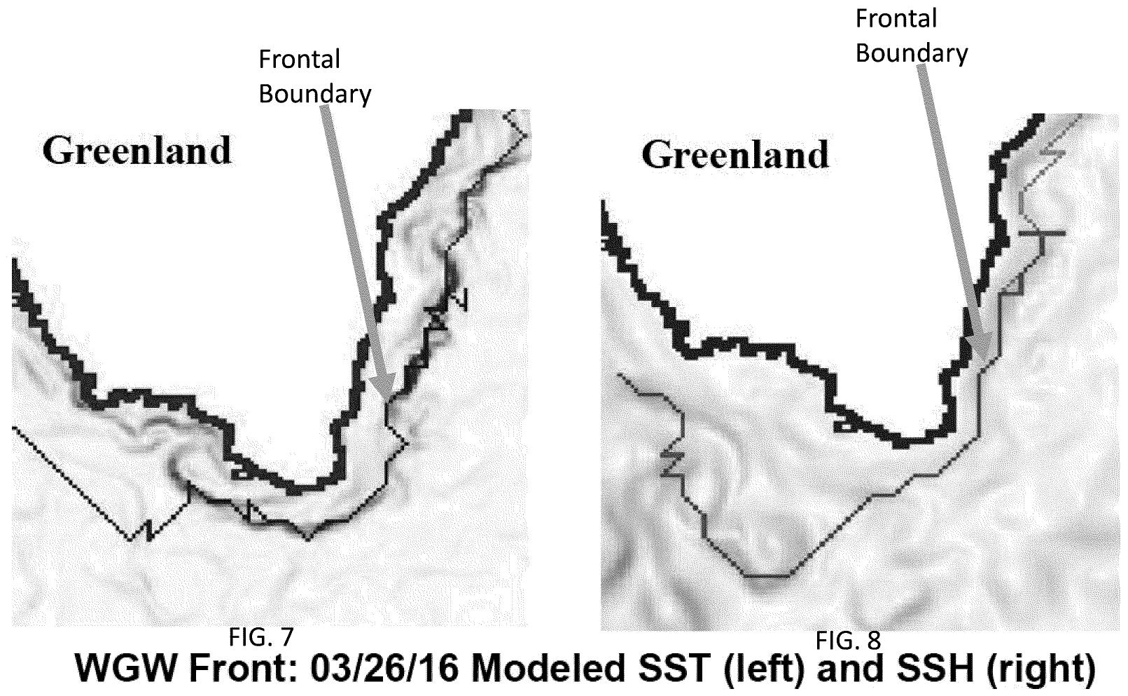

FIGS. 7 and 8 show illustrations of the WGW Front: Mar. 26, 2016 Modeled SST (left) and SSH (right), in accordance with one or more disclosed aspects.

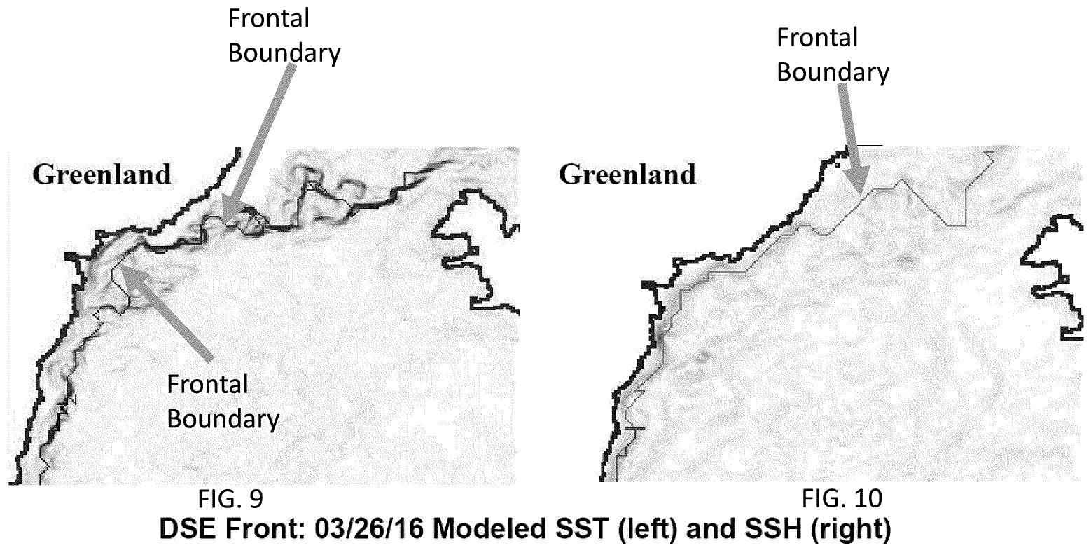

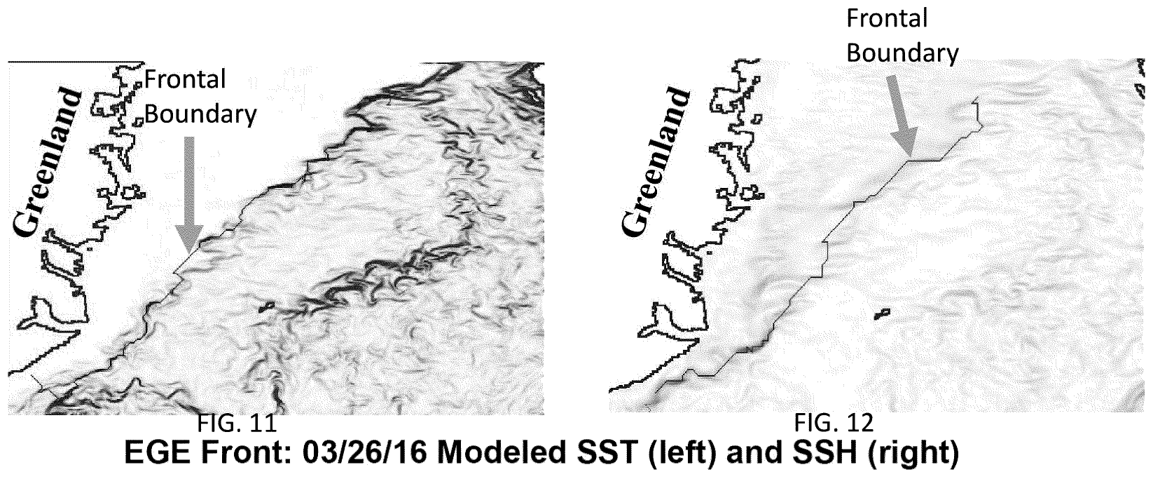

FIGS. 9 and 10 show illustrations of the DSE Front: Mar. 26, 2016 Modeled SST (left) and SSH (right), in accordance with one or more disclosed aspects.

FIGS. 11 and 12 show illustrations of the EGE Front: Mar. 26, 2016 Modeled SST (left) and SSH (right), in accordance with one or more disclosed aspects.

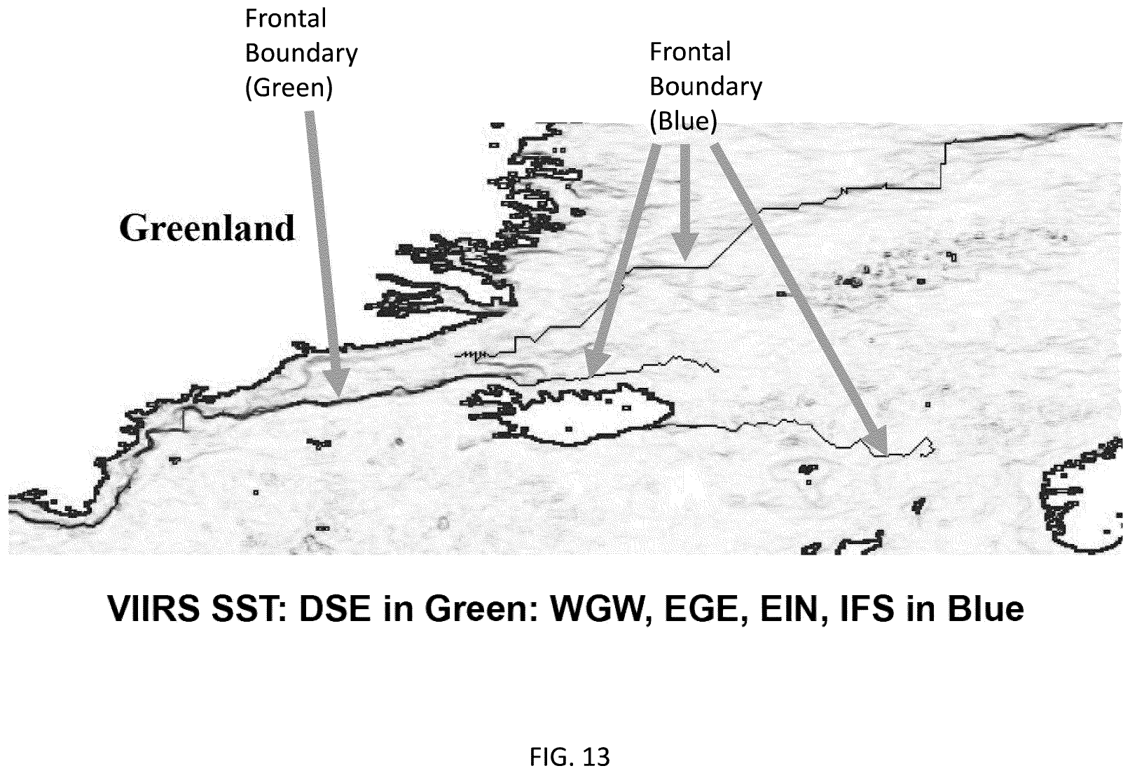

FIG. 13 shows an illustration of VIIRS SST: DSE in Green: WGW, EGE, EIN, IFS in Blue, in accordance with one or more disclosed aspects.

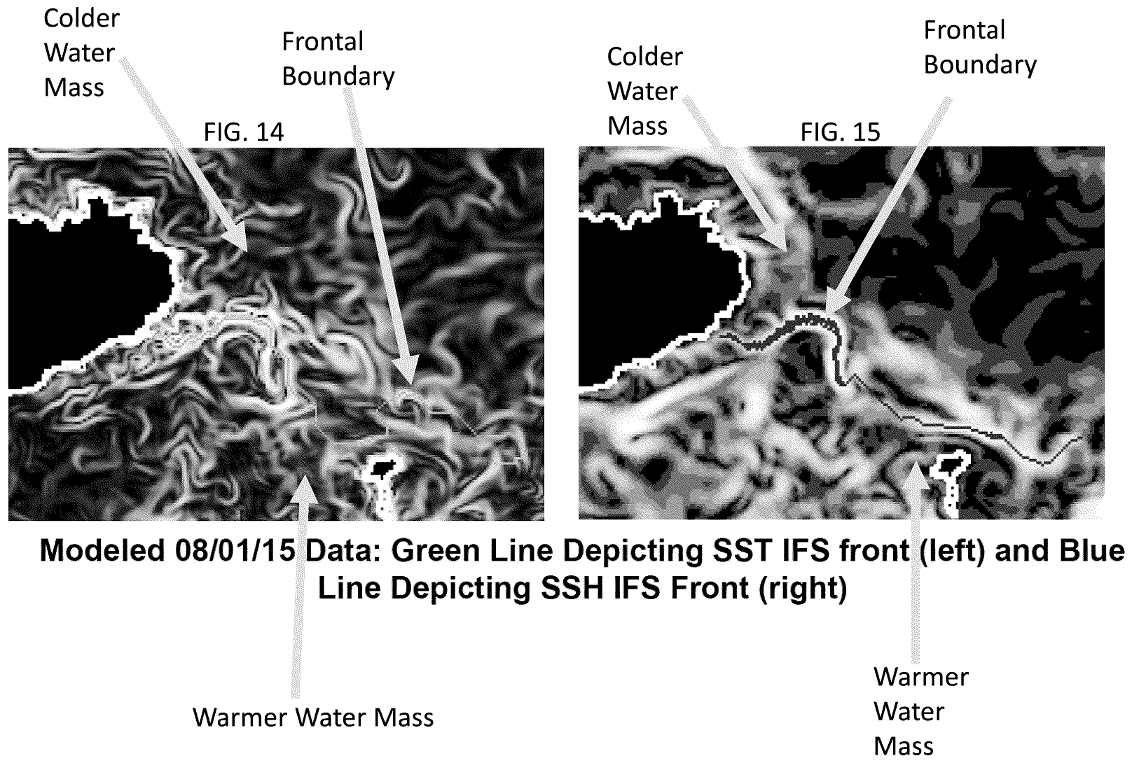

FIG. 14 shows an illustration, in the image of sea surface temperature gradients (modeled Aug. 1, 2015 data), of a frontal boundary between the warmer water mass to the south and the colder water mass to the north at the Iceland Faro Primary (IFS) front that was generated by one or more disclosed embodiments, in accordance with one or more disclosed aspects.

FIG. 15 shows an illustration, in the image of sea surface height gradients (modeled Aug. 1, 2015 data), of a frontal boundary between the less dense water mass to the south from the denser water mass to the north at the IFS front that was generated by one or more disclosed embodiments, in accordance with one or more disclosed aspects.

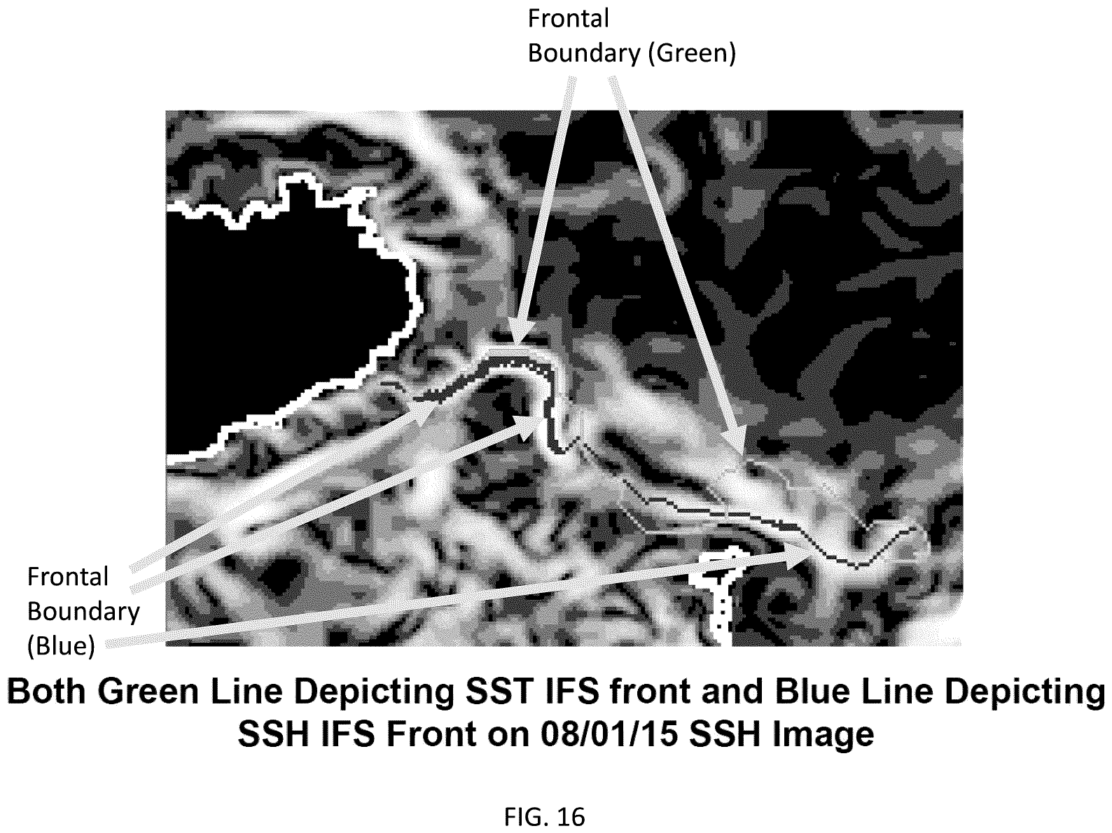

FIG. 16 shows an illustration of Both Green Line Depicting SST IFS front and Blue Line Depicting SSH IFS Front on Aug. 1, 2015 SSH Image, in accordance with one or more disclosed aspects.

The gradient generation and algorithm to delineate and trace across high gradient values identified current frontal boundaries in both observed and modeled data sets. The resulting fronts from different ocean products can be used to study the movement of front of interest over time as seen from different ocean products. The resulting vector lines can be compared to explore relationships between the characterization of the front as seen by these different ocean products.
In some embodiments, one or more aspects may include adjusting the pruning so more options are left at the end of tracing.
In some embodiments, one or more aspects may include adjusting the front performance measurement to better balance gradient average and length of front.
In some embodiments, one or more aspects may include extending one or more disclosed aspects to include other regions of the globe.

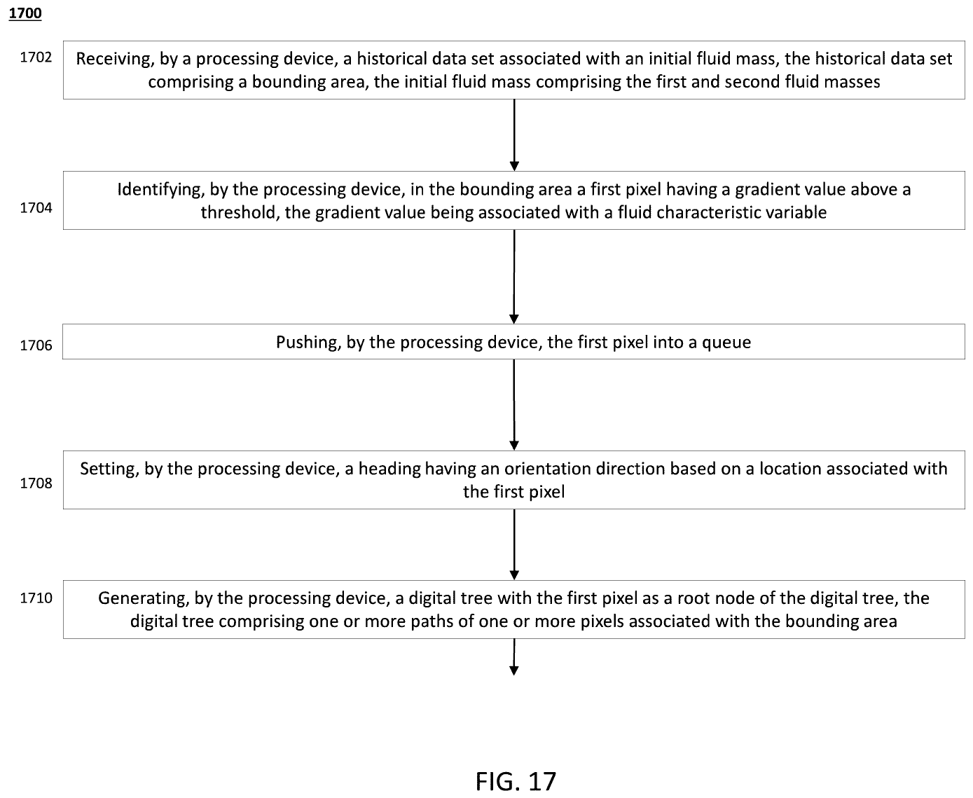

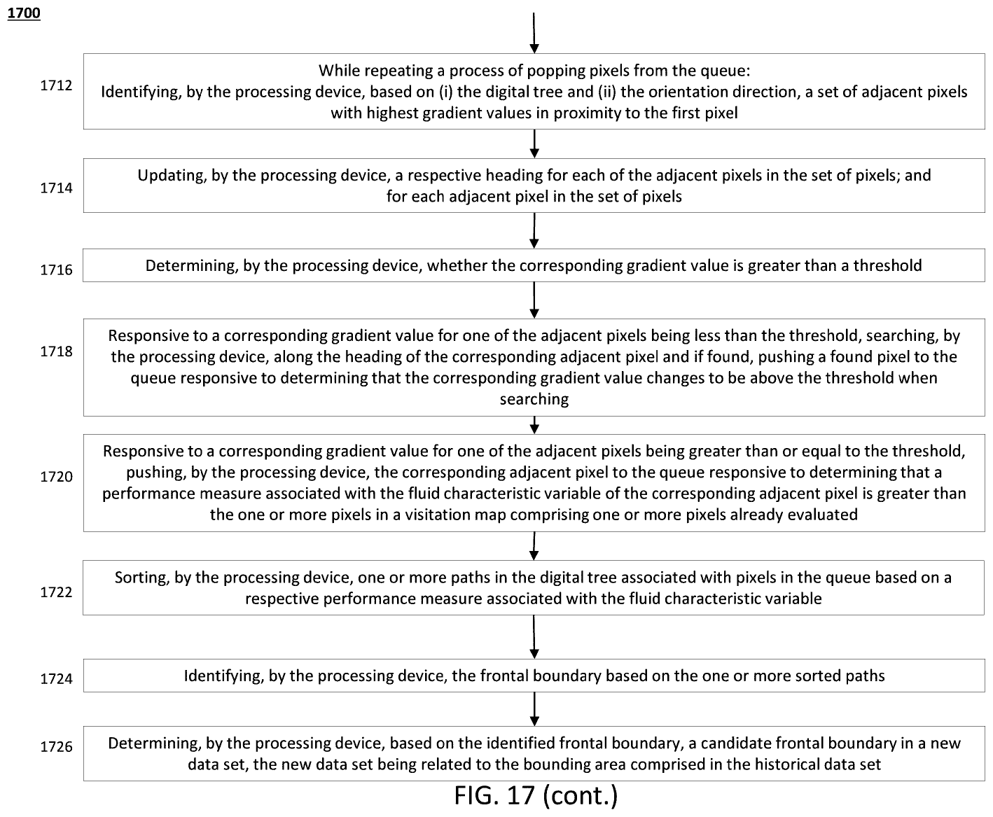

FIG. 17 illustrates an example method 1700, in accordance with one or more disclosed aspects. For example, the method 1700 may be for a method of identifying a frontal boundary between a first fluid mass and a second fluid mass based on a fluid property.

Step 1702 may include receiving, by a processing device, a historical data set associated with an initial fluid mass, the historical data set comprising a bounding area, the initial fluid mass comprising the first and second fluid masses.

Step 1704 may include identifying, by the processing device, in the bounding area a first pixel having a gradient value above a threshold, the gradient value being associated with a fluid characteristic variable.

Step 1706 may include pushing, by the processing device, the first pixel into a queue.

Step 1708 may include setting, by the processing device, a heading having an orientation direction based on a location associated with the first pixel.

Step 1710 may include generating, by the processing device, a digital tree with the first pixel as a root node of the digital tree, the digital tree comprising one or more paths of one or more pixels associated with the bounding area.

Step 1712 may include while repeating a process of popping pixels from the queue: identifying, by the processing device, based on (i) the digital tree and (ii) the orientation direction, a set of adjacent pixels with highest gradient values in proximity to the first pixel.

Step 1714 may include updating, by the processing device, a respective heading for each of the adjacent pixels in the set of pixels, and for each adjacent pixel in the set of pixels.

Step 1716 may include determining, by the processing device, whether the corresponding gradient value is greater than a threshold.

Step 1718 may include responsive to a corresponding gradient value for one of the adjacent pixels being less than the threshold, searching, by the processing device, along the heading of the corresponding adjacent pixel and if found, pushing a found pixel to the queue responsive to determining that the corresponding gradient value changes to be above the threshold when searching.

Step 1720 may include responsive to a corresponding gradient value for one of the adjacent pixels being greater than or equal to the threshold, pushing, by the processing device, the corresponding adjacent pixel to the queue responsive to determining that a performance measure associated with the fluid characteristic variable of the corresponding adjacent pixel is greater than the one or more pixels in a visitation map comprising one or more pixels already evaluated.

Step 1722 may include sorting, by the processing device, one or more paths in the digital tree associated with pixels in the queue based on a respective performance measure associated with the fluid characteristic variable.

Step 1724 may include identifying, by the processing device, the frontal boundary based on the one or more sorted paths.

Step 1726 may include determining, by the processing device, based on the identified frontal boundary, a candidate frontal boundary in a new data set, the new data set being related to the bounding area comprised in the historical data set.

One or more steps may be repeated, added, modified, and/or excluded. One or more steps may be performed by a computer, computing device, processing device, or the like, such as the one described herein and shown in FIG. 18.

According to some aspects, one or more disclosed embodiments may have one or more specific applications. Identifying frontal boundaries provide interesting possibilities for evaluating water masses. For example, disclosed aspects may be used for search & rescue, for implementing and/or developing a mission route plan associated with operating a vehicle, aircraft, vessel, and/or the like. According to some aspects, one or more disclosed aspects may be used to facilitate a water-based operation. In some cases, one or more disclosed aspects may be used to facilitate a strategic operation, which can include a defensive tactical operation or naval operation. Since ocean fronts separate water masses of different physical and biogeochemical properties, they play an important part in several industries, including prediction of wildlife movement (e.g., fish school locations, etc.), weather prediction and forecasting, and climate prediction. Fronts are often associated with nutrients and aquatic organisms, which attract a variety of marine life drawn to these nutrients and organisms. Therefore, the identification of frontal boundaries can define optimal locations to direct fishing vessels. Air masses on either side of frontal boundaries can be affected by temperature differences across the front. Therefore, accurate identification of frontal boundaries can help improve accuracy and reliability of weather forecasts. Relationships between wind and sea surface height can be used to improve seasonal to decadal coastal sea level forecasts. Frontal boundary information can also be used as inputs of ocean and acoustic models to improve those models.

One or more aspects described herein may be implemented on virtually any type of computer regardless of the platform being used. For example, as shown in FIG. 18, a computer system 1800 includes a processor 1802, associated memory 1804, a storage device 1806, and numerous other elements and functionalities typical of today's computers (not shown). The computer 1800 may also include input means 1808, such as a keyboard and a mouse, and output means 1812, such as a monitor or LED. The computer system 1800 may be connected to a local may be a network (LAN) or a wide may be a network (e.g., the Internet) 1814 via a network interface connection (not shown). Those skilled in the art will appreciate that these input and output means may take other forms.

Further, those skilled in the art will appreciate that one or more elements of the aforementioned computer system 1800 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments for identifying a frontal boundary between a first fluid mass and a second fluid mass have been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

What is claimed is:

1. A method of identifying a frontal boundary between a first fluid mass and a second fluid mass based on a fluid property, comprising:
receiving, by a processing device, a historical data set associated with an initial fluid mass, the historical data set comprising a bounding area, the initial fluid mass comprising the first and second fluid masses;
identifying, by the processing device, in the bounding area, a first pixel having a gradient value above a threshold, the gradient value being associated with a fluid characteristic variable;
pushing, by the processing device, the first pixel into a queue;
setting, by the processing device, a heading having an orientation direction based on a location associated with the first pixel;
generating, by the processing device, a digital tree with the first pixel as a root node of the digital tree, the digital tree comprising one or more paths of one or more pixels associated with the bounding area;
while repeating a process of popping pixels from the queue:
identifying, by the processing device, based on (i) the digital tree and (ii) the orientation direction, a set of adjacent pixels with highest gradient values in proximity to the first pixel;
updating, by the processing device, a respective heading for each of the adjacent pixels in the set of pixels; and
for each adjacent pixel in the set of pixels,
determining, by the processing device, whether the corresponding gradient value is greater than a threshold,
responsive to a corresponding gradient value for one of the adjacent pixels being less than the threshold, searching, by the processing device, along the heading of the corresponding adjacent pixel and if found, pushing a found pixel to the queue responsive to determining that the corresponding gradient value changes to be above the threshold when searching, and
responsive to a corresponding gradient value for one of the adjacent pixels being greater than or equal to the threshold, pushing, by the processing device, the corresponding adjacent pixel to the queue responsive to determining that a performance measure associated with the fluid characteristic variable of the corresponding adjacent pixel is greater than the one or more pixels in a visitation map comprising one or more pixels already evaluated;
sorting, by the processing device, one or more paths in the digital tree associated with pixels in the queue based on a respective performance measure associated with the fluid characteristic variable;
identifying, by the processing device, the frontal boundary based on the one or more sorted paths; and
determining, by the processing device, based on the identified frontal boundary, a candidate frontal boundary in a new data set, the new data set being related to the bounding area comprised in the historical data set.

2. The method of claim 1, wherein responsive to determining, for each adjacent pixel in the set of pixels, that a current adjacent pixel is already part of N paths and if the current adjacent pixel's route has a better performance value than one or more pixels in the visitation map, replacing a lowest performing pixel in the visitation map with the current adjacent pixel.

3. The method of claim 1, wherein the first pixel comprises a pixel with a gradient value above the threshold on a westernmost side of the bounding area.

4. The method of claim 3, wherein comprising setting the heading as a heading of east at 90 degrees.

5. The method of claim 1, wherein the performance measure comprises an average gradient of one or more of the adjacent pixels.

6. The method of claim 1, wherein the set of adjacent pixels comprises 5 adjacent pixels.

7. The method of claim 6, wherein 3 adjacent pixels with a highest gradient value are selected from the 5 adjacent pixels.

8. The method of claim 1, wherein the initial fluid mass associated in the historical data set has a different configuration than a fluid mass in the new data set.

9. The method of claim 1, wherein the fluid characteristic variable comprises Sea Surface Temperature (SST).

10. The method of claim 1, wherein the fluid characteristic variable comprises Sea Surface Height (SSH).

11. The method of claim 1, the fluid characteristic variable comprises an ocean characteristic product.

12. The method of claim 1, the new data set is of a substantially similar geographical location as the historical data set.

13. The method of claim 1, the new set of data is of a substantially similar annual seasonal timeframe as the historical data set.

14. The method of claim 1, wherein the historical data set is associated with Sea Surface Temperature (SST).

15. The method of claim 1, wherein the historical data set is associated with Sea Surface Height (SSH).

16. The method of claim 1, wherein the historical data set is associated with an ocean characteristic product.

17. The method of claim 1, wherein the historical data set comprises a set of raster images.

18. The method of claim 1, further comprising displaying the identified frontal boundary on a display of the historical data.

19. The method of claim 1, wherein the historical data set comprises a modeled ocean product data set.

20. The method of claim 1, wherein the historical data set comprises an observed ocean product data set.

21. The method of claim 1, wherein the new data set is derived from a modeled ocean product data set.

22. The method of claim 1, wherein the new data set is derived from an observed ocean product data set.

24. The method of claim 1, further comprising performing a water-based operation based on the determined candidate frontal boundary.

25. The method of claim 1, further comprising performing a water-based operation based on the identified frontal boundary.

26. The method of claim 1, further comprising using a Sobel gradient method to determine the gradient value.

27. The method of claim 1, wherein the fluid characteristic variable is associated with a liquid.
